(19) United States
(12) Patent Application Publication
(10) Pub. No.: US 2019/0358870 A1
(43) Pub. Date: Nov. 28, 2019

(54) METHOD AND DEVICE FOR FORMING AND INSTALLING MOULDINGS

(71) Applicant: Herman Grewal, Paris (CA)

(72) Inventor: Herman Grewal, Paris (CA)

(21) Appl. No.: 16/419,081

(22) Filed: May 22, 2019

Related U.S. Application Data
(60) Provisional application No. 62/675,345, filed on May 23, 2018.

(51) Int. Cl. B29C 44/50; E04B 1/35

(52) U.S. Cl. CPC B29C 44/507; E04B 2001/6195; E04B 1/3505

(57) ABSTRACT

An apparatus for the in-situ formation of a moulding. The apparatus includes a forming head and a forming blade. The forming head has a body having a raw material receiver. The body further has one or more outlets to permit the movement of raw material from the raw material receiver through an outer surface of the body and into an area adjacent to a work surface when the forming head is positioned in proximity to the work surface. The forming blade is secured to the body and imparts a desired profile shape to raw material deposited adjacent to the work surface as the forming head is moved along the work surface.

### CROSS REFERENCE TO RELATED APPLICATIONS

This patent application claims priority on and the benefit of U.S. Provisional Patent Application No. 62/675,345 having a filing date of 23 May 2018.

### FIELD OF THE INVENTION

The present invention relates to the making of architectural mouldings and more particularly relates to a device for forming and installing mouldings in situ using structural expanding foam in residential and commercial construction and renovation.

### BACKGROUND OF THE INVENTION

Mouldings are popular architectural features used in residential and commercial construction and renovation to cover transitions between surfaces, such as the junction between walls and ceilings, and between walls and floors. They may also be used in capping walls, pilasters and cabinets. There is great variation in the height, profiles and designs of mouldings commercially available and the materials used to make mouldings include plaster, solid wood, medium density fibreboard, polyurethane, PVC, fiberglass, polystyrene and plaster-coated foam mouldings.

The installation of moulding is normally a time-intensive process requiring careful measurement of the dimensions of the surface to which the moulding is to be applied, and precise cutting of the moulding. Mistakes can result in unattractive gaps between moulding strips, particularly where moulding pieces intersect at corners, where two adjacent moulding pieces otherwise abut, or at the intersection of the walls and floor of a structure.

The present invention seeks to simplify the production and installation of mouldings using structural expanding foam that, is extruded directly onto the surface to which the moulding is to be applied, and formed into a moulding of the desired height and profile in place.

### BRIEF DESCRIPTION OF THE DRAWINGS

The present will now be described by way of example only with reference to the following drawings in which:

FIG. 1 is a front top perspective view of a forming head in accordance with an embodiment of the invention.

FIG. 2 is a left side elevation view of the forming head of FIG. 1.

FIG. 3 is a top plan view of the forming head of FIG. 1.

FIG. 4 is a front elevation view of the forming head of FIG. 1.

FIG. 5 is a front, top, left side perspective view of a profile blade in accordance with an embodiment of the invention.

FIG. 6 is a top plan view of the blade of FIG. 5.

FIG. 7 is a left side elevation view of the blade of FIG. 5.

FIG. 8 is a rear, bottom, right perspective view of the blade of FIG. 5.

FIG. 9 is a bottom view of the blade of FIG. 5.

FIG. 10 is a front bottom perspective view of the forming head in use with a blade.

FIG. 11 is a top plan view of an alternate embodiment of a blade and locating member.

FIG. 12 is a side plan view of an alternate embodiment of a blade and locating member.

FIG. 13 is a representation of the foam delivery system in use with the forming head.

FIG. 14 is a schematic representation of a profile blade of an embodiment of the invention, in use with the structural expanding foam to produce a finished moulding.

FIG. 15 is a schematic representation similar to FIG. 14, but viewed from an opposite direction.

FIG. 16 is a schematic representation of the forming head, in accordance with an embodiment of the invention, in use against a wall to produce and install moulding.

FIG. 17 is a schematic representation of the forming head, in accordance with an embodiment of the invention, in use against a wall to produce and install moulding.

FIG. 18 depicts an alternate embodiment of the invention that utilizes robotics to move the forming head.

FIG. 19 shows the robotically operated device of FIG. 18 in operation.

FIG. 20 shows a baseboard moulding having been formed along two wall structures by the robotic device of FIG. 18.

FIG. 21 is a partially exploded view of the robotic carrier portion of the device shown in FIG. 18.

FIG. 22 is an upper side perspective view of the robotic device shown in FIG. 18.

FIG. 23 is a partially exploded view of an alternate embodiment of the robotic carrier of the device shown in FIG. 18.

### DETAILED DESCRIPTION OF PREFERRED EMBODIMENTS

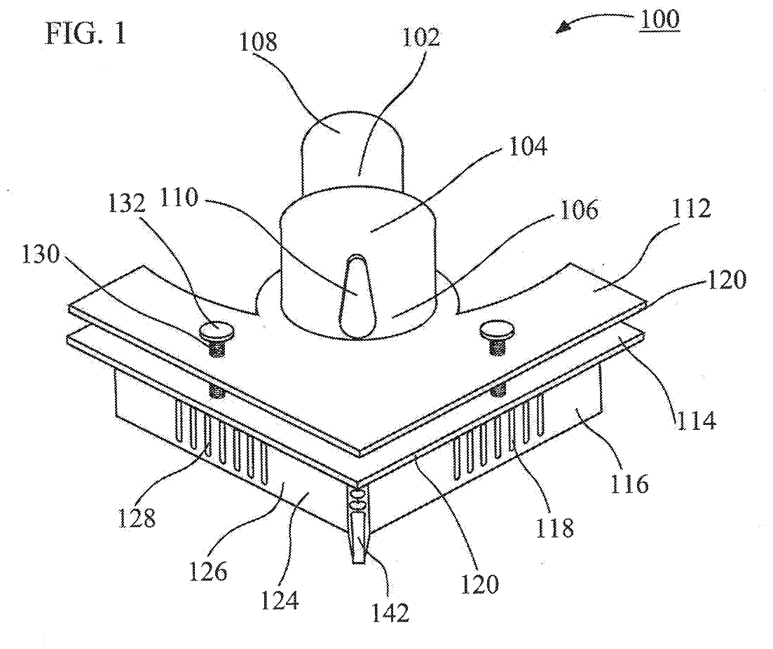

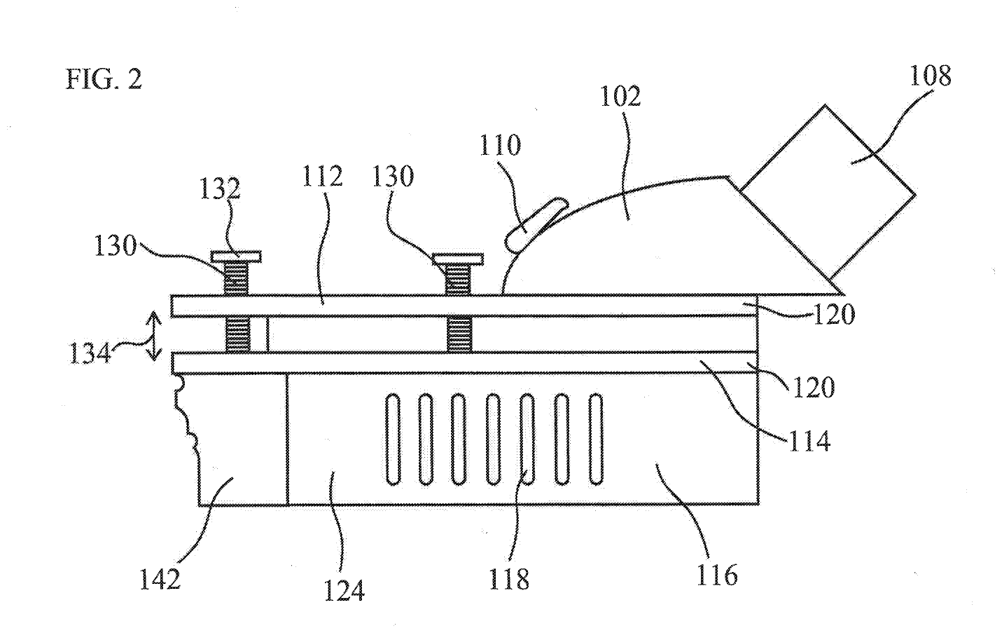

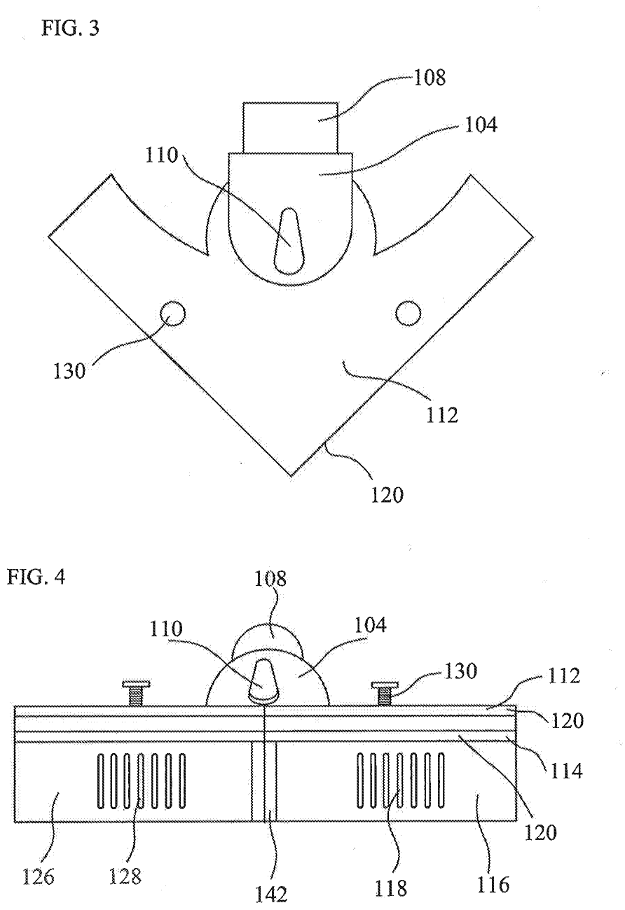

Referring first to FIGS. 1, 2, 3, and 4 which schematically depict forming head 100 which comprises foam receiver 102, mixing chamber 104, valve housing 106, handle 108, top plate 112, adjustable guide plate 114, body 124 and blade 142. Handle 108 is swivelably mounted to mixing chamber 104 and valve housing 106.

Body 124 is comprised of a left side 116 and a right side 126 which each have a respective outlet, left outlet 118 and right outlet 128. Blade 142 is installed at the intersection of left side 116 and right side 126.

Top plate 112 and adjustable guide plate 114 are separated by adjusting screws 130. Adjusting screws 130 have thumb wheel 132 which allows the user to turn adjusting screws 130 to adjust the height between top plate 112 and adjustable guide plate 114. Customized heights of mouldings can be produced by varying the height between top plate 112 and adjustable guide plate 114 in adjusting direction 134. Top plate 112 and adjustable guide plate 114 each have guide edge 120 that rests against the wall while forming head 100 is in use.

Valve housing 106 includes valve selector 110 which is used to switch the flow of structural expanding foam 150 between left outlet 118 and right outlet 128.

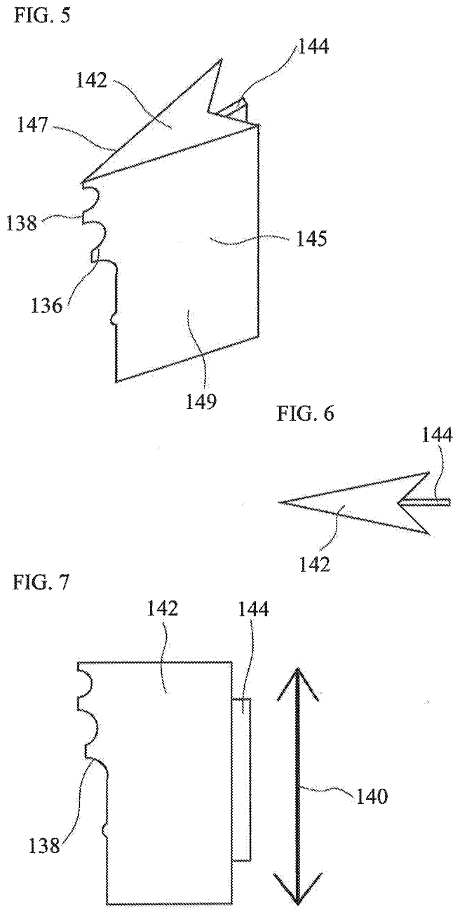

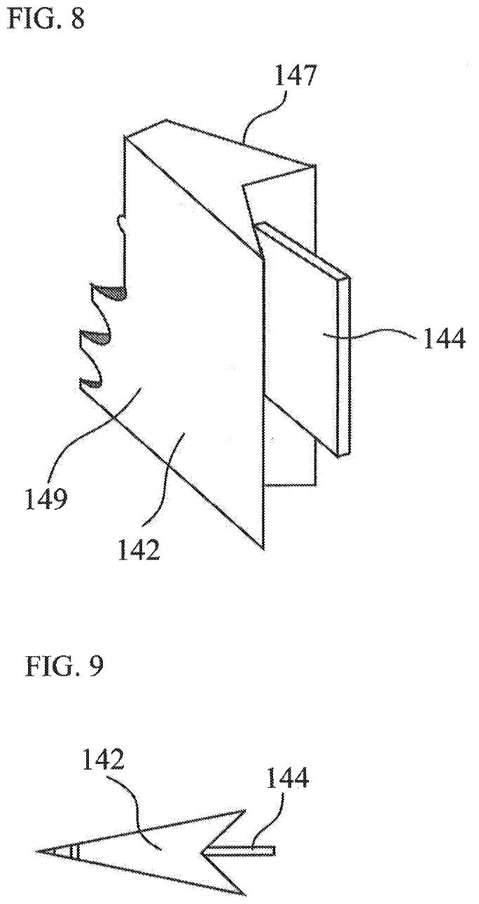

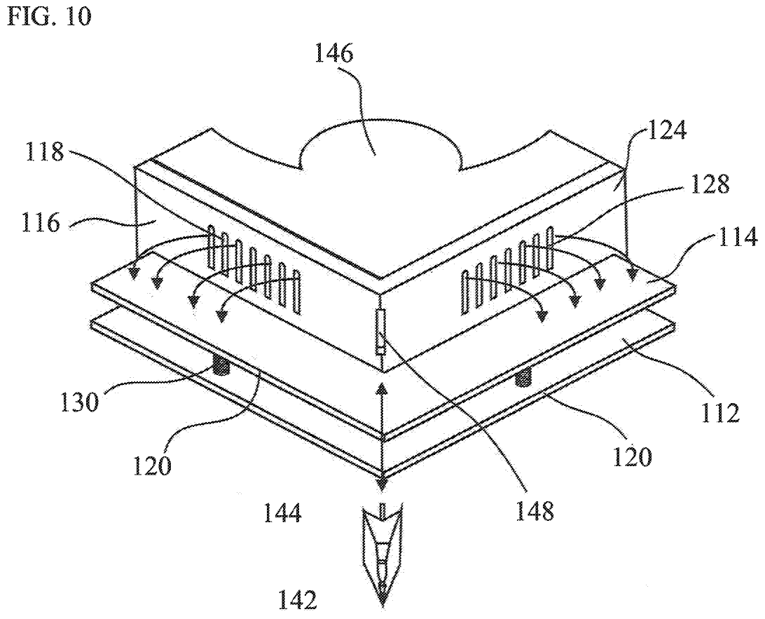

Referring now to FIGS. 5, 6, 7, 8, and 9 which depict a blade 142 for use with forming head 100. Blade 142 comprises a main body 145 with forming edge 138, right side 147, left side 149 and locating member 144. Forming edge 138 has contours 136 which define the profile of the moulding to be made. Locating member 144 connects blade 142 to forming head 100. When blade 142 is installed in forming head 100, left side 149 is continuous with left side 116 of forming head 100 and right side 147 is continuous with right side 128 of forming head 100.

FIG. 10 shows bottom surface 146 of forming head 100 and slot 148 which receives locating member 144 of blade 142.

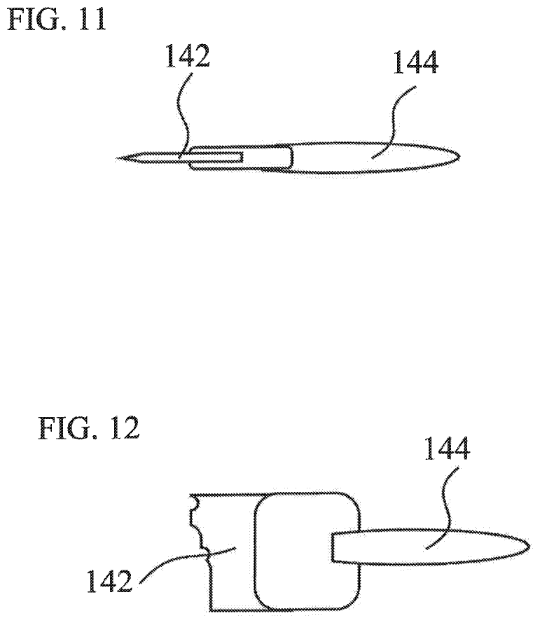

FIGS. 11 and 12 show an alternate locating member 144 which could be used. In practice, the locating member 144 could take on any number of configurations and shapes and still be effective.

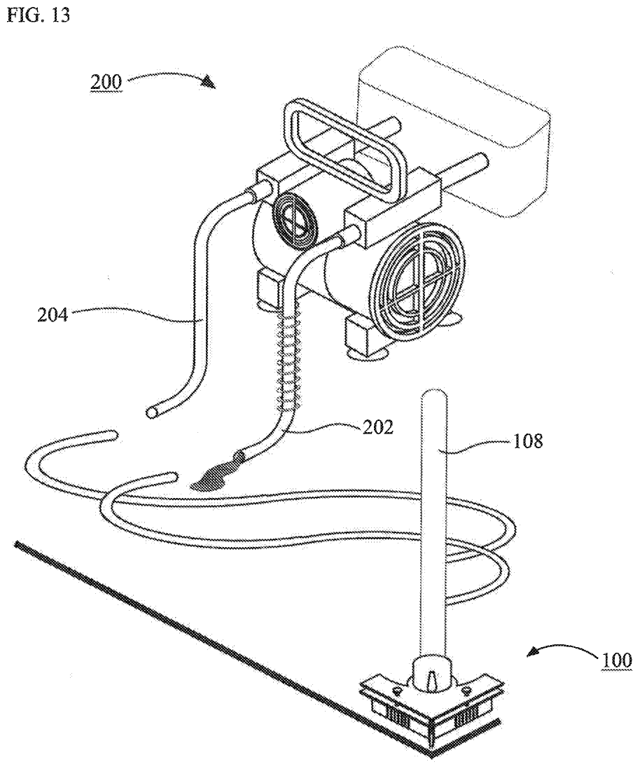

FIG. 13 shows a schematic representation of forming head 100 in use with foam delivery system 200. Typically, foam delivery system 200 will be connected to forming head 110 by first delivery conduit 202 and second delivery conduit 204 which feed separate chemicals (the nature of which will be known to those skilled in the art) that are mixed in mixing chamber 104 to create structural expanding foam 150 within forming head 100. It is expected that in many instances a two-component foam will be utilized, where the foam product is produced through the mixing of two primary liquid components. Other forms of foam products may also be utilized, including pre-mixed foams in aerosol cans. It will also be appreciated that while the foam will tend to expand to a degree when being formed from its component parts, for the application at hand a relatively low expansion foam will in most instances be preferred. It should be further appreciated that while foam has been described as the material from which the mouldings are formed, in alternate embodiments the mouldings in question could be formed from other component materials, including plaster, concrete, plastics, polymers, or other such products that can be moulded and that will “set” in a sufficient time to enable the formation of a moulding as described and in a manner as discussed below.

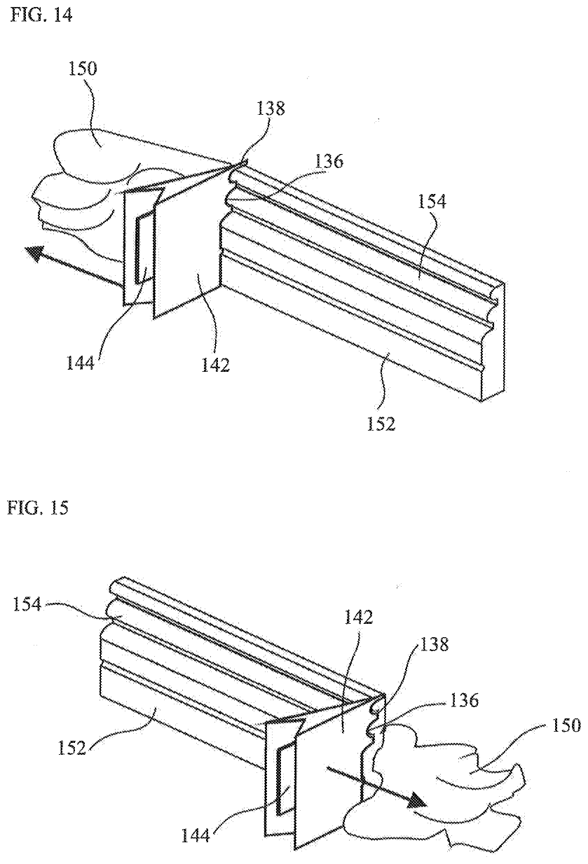

FIGS. 14 and 15 depict blade 142 in use with structural expanding foam 150 to create finished moulding 152 (for illustrative purposes forming head 100 has not been shown). Forming edge 138 rests against the wall and contours 136 define the curved decorative details 154 of the finished moulding. Structural expanding foam 150 is compressed between the wall and blade 142 thereby defining the shape defined of decorative detail 154 by use of the profile of the forming edge 138 of blade 142.

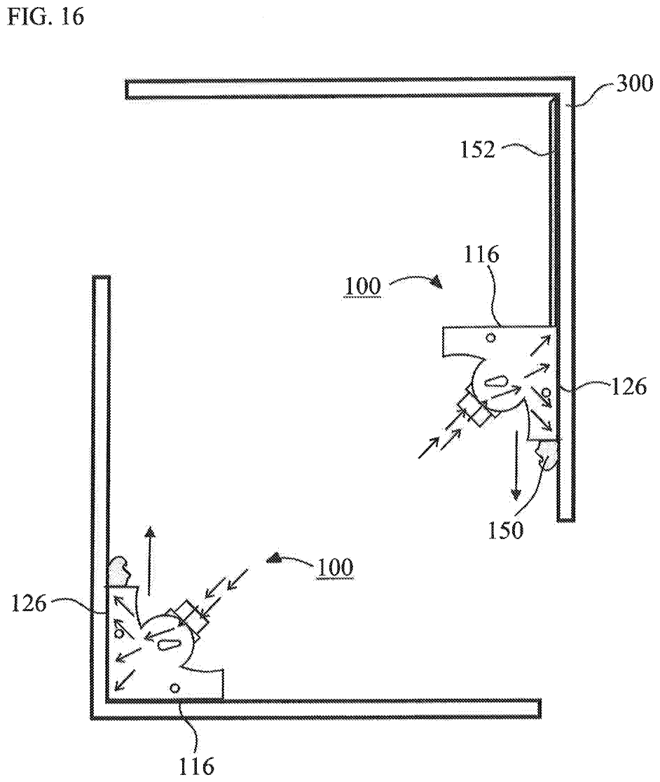

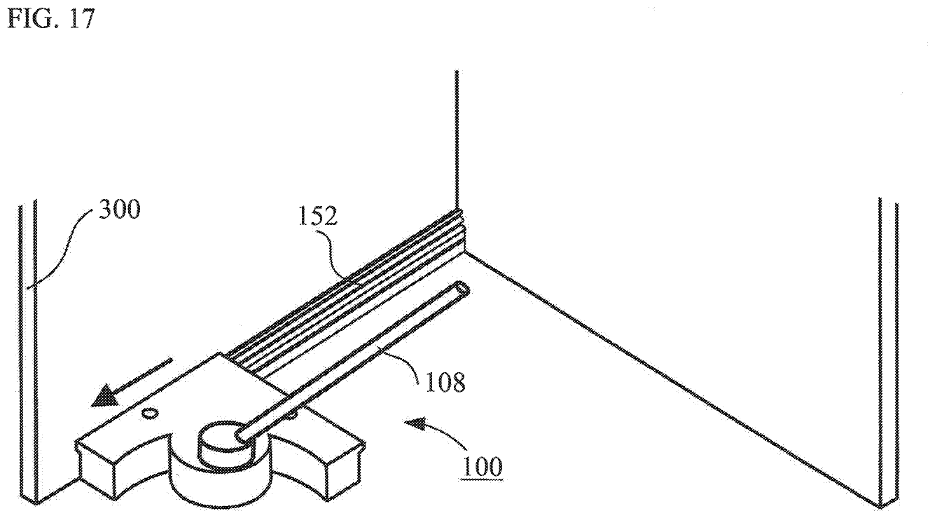

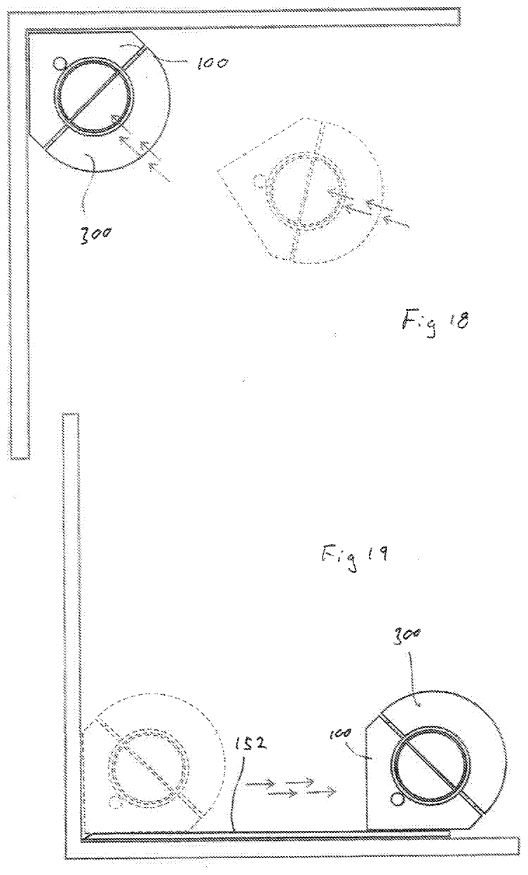

FIGS. 16 and 17 depict the use of forming head 100 against wall 300 to turn structural expanding foam 150 into finished moulding 152. Structural expanding foam 150 is directed to either left side 116 or right side 126 of forming head 100, whichever side is in use against wall 300. In FIG. 16, structural expanding foam 150 is directed by valve selector 110 to right side 126 of each forming head 100 to be released out of right outlet 128.

In use, finished mouldings can be produced and installed at the same time in situ using forming head 100 in combination with a foam delivery system 200 and blade 142. A pre-selected blade height 140 and forming edge 138 are chosen for the particular decorative detail 154 that is desired. Forming head 100 is held against the wall on which the moulding is to be applied, with guiding edge 120 of either left side 116 or right side 126 abutting the wall. The height between top plate 112 and adjustable guide plate 114 is adjusted for the desired height of the moulding.

The chemicals that form structural expanding foam 150 can then be released from foam delivery system 200 through first delivery conduit 202 and second delivery conduit 204 to mixing chamber 104. In some cases formation of the structural foam may require an activating agent or ingredient. In such cases it may be desirable for the activating ingredient to be added at mixing chamber, before the foam is released through valve housing 106 to left outlet 118 or right outlet 128. Valve selector 110 is used by the operator to set the direction of the flow of structural expanding foam 150 to the side of the foaming head 100 set against the wall.

Forming head 100 holds blade 142 against the wall, applying constant pressure as the operator moves forming head 100 alongside the wall. As forming head 100 is moved or moves along the length of the wall, structural expanding foam 150 is shaped by forming edge 138 of blade 142 into the desired finished moulding 152.

The present method and device can provide time and cost-savings as mouldings are formed and installed at the same time. Precise measurements and cuts of pre-made mouldings are not required.

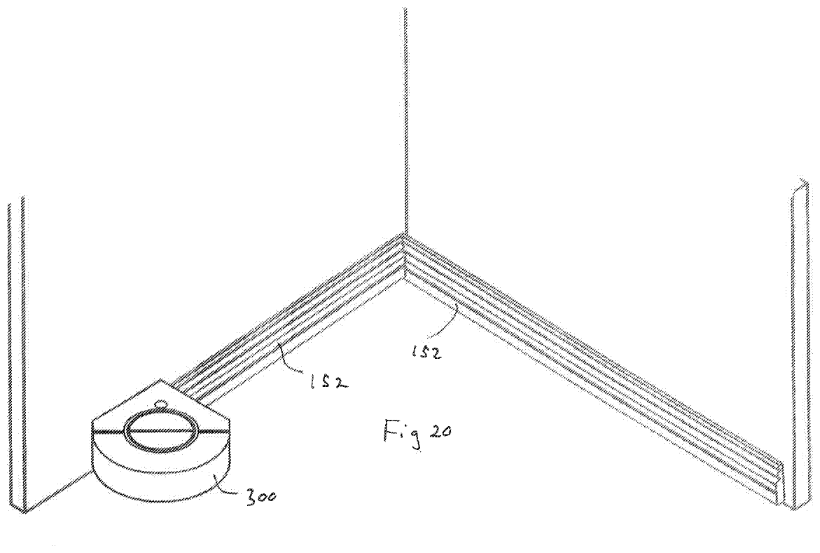

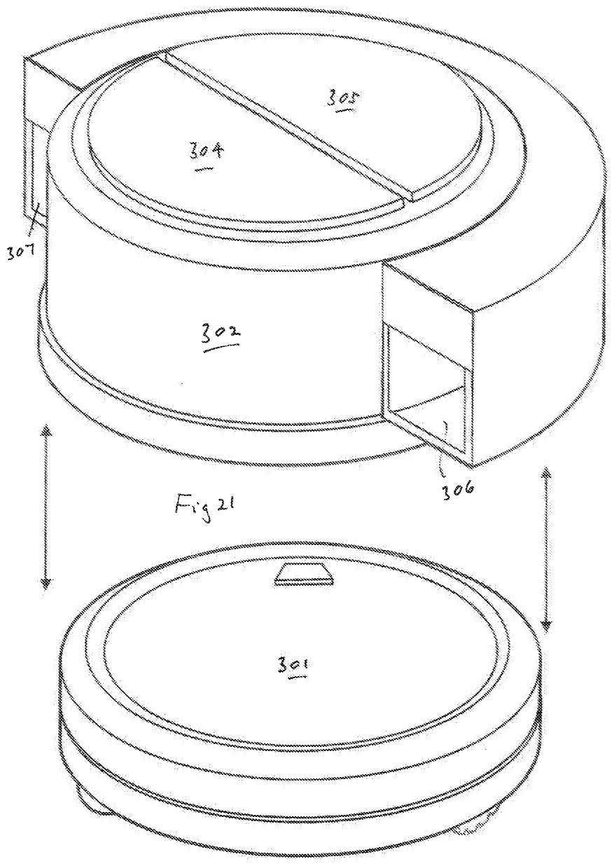

FIGS. 18 through 23 show alternate embodiments of the invention. In this instance forming head 100 is mounted upon an autonomous or semi-autonomous robotic carrier 300. With a full understanding of the invention, one of skill in the art will appreciate that robotic carrier 300 could take one of any wide variety of different forms or structures including, but not limited to, devices similar or substantially the same as currently available robotic vacuum cleaners.

Typically, robotic carrier 300 will include an internal battery to act as a power source, but could also be tethered to an external power source. Robotic carrier 300 would also include drive motors, drive wheels, and a variety of sensors that deliver data to an onboard central processor to aid in navigation, propulsion, positioning and operation. In some instances, it may also be desirable to download scaled drawings of a building or structure into memory of the onboard processor such that robotic carrier is “self-aware” of the locations within a particular room where moulding is to be applied (for example the location of the wall structures where a baseboard moulding is desired). In other instances, operation or partial operation of robotic carrier 300 may be accomplished through wireless connections to centralized control systems, on-site computers or processors, or through an “App” on a smart phone. Once again, it will be appreciated by one of skill in the art that the mode of operation of such robotic carriers is well known and can be based upon pre-existing and downloaded data points, and/or through the operation of various proximity and locating sensors, including cameras, radar, LIDAR, sonic and ultrasonic sensors, lasers, etc.

In the embodiments shown in FIGS. 18 through 23, the method of forming finished moulding 152, and the general overall structure of forming head 100 will be largely the same as that shown in FIGS. 1 through 17. The primary difference in the embodiments of FIGS. 18 through 23 is simply the mode of movement of forming head 100. Whereas in the earlier described embodiment forming head 100 is moved manually by an operator along a wall, floor or other surface. In the embodiments of FIGS. 18 through 23 movement is automated or semi-automated through the use of robotic carrier 300.

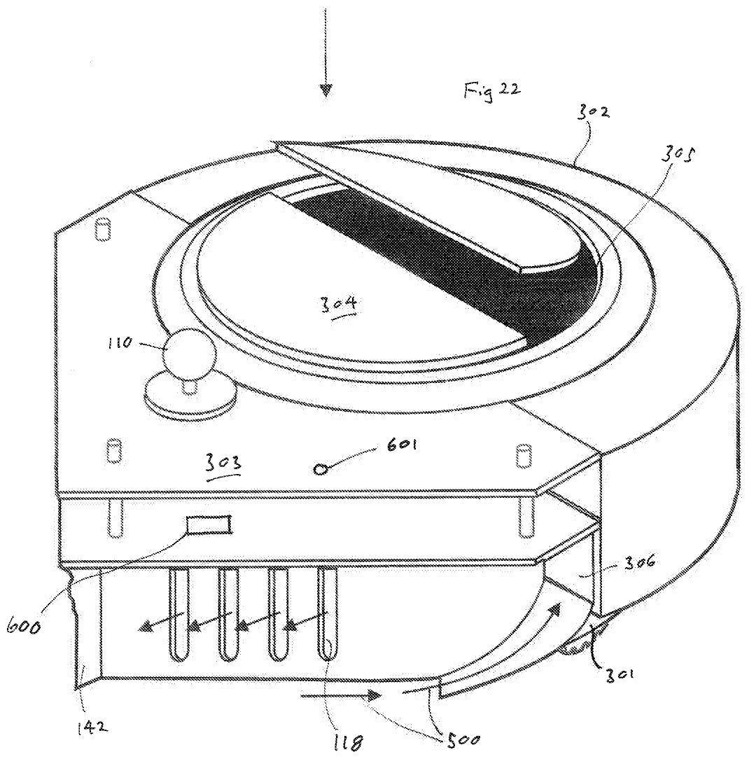

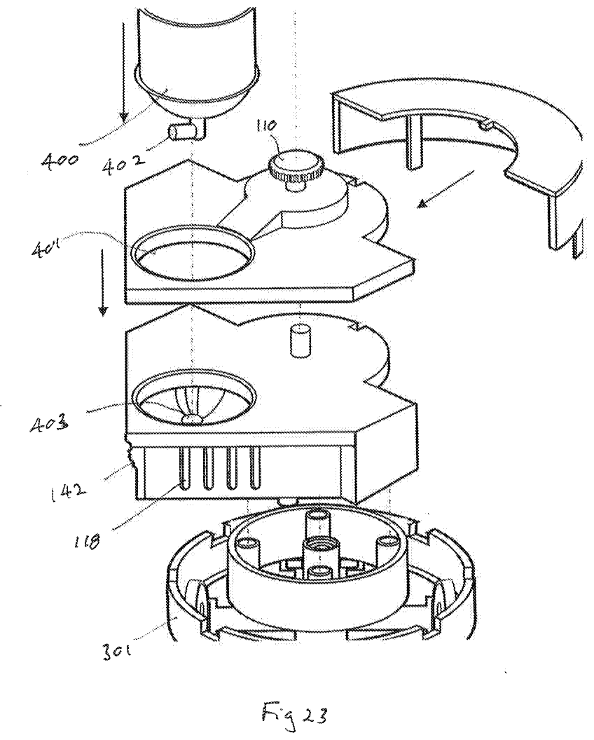

With specific reference to FIGS. 21 and 22, robotic carrier 300 is shown as comprised of a lower drive portion 301, an upper reservoir housing 302, and a forming head 303 specifically adapted for the robot carrier. Lower drive portion 301 will typically contain the drive components, power source, sensors, memory, wireless receivers or transmitters where required, and such other mechanisms and devices commonly required to enable autonomous or semi-autonomous movement and control of similar devices.

Upper reservoir housing 302 will typically be mounted on top of lower drive portion 301 and in many cases will contain two separate compartments or reservoirs 304 and 305 for storing the two components from which expanding foam 150 is to be created. It will, however, be understood that one, two, or more reservoirs could be incorporated into housing 302, depending upon the nature of the product from which the moulding is to be created and how that product is formed. Upper reservoir housing 302 could also contain a vacuum system drawing excess material away from forming head 100 through openings 306 or 307 (as the case may be depending on which direction the forming head is being moved) for storage within housing 302 and ultimately for disposal.

As indicated, for the most part forming head 100 in the embodiment of FIGS. 18 through 23 is substantially the same as that of FIGS. 1 through 17, with appreciable modifications to permit it to be mounted upon robotic carrier 300. In operation, the components in which expanding foam 150 are created will be withdrawn from reservoirs 304 and 305, combined, (depending on the position of selector valve 110) through either left outlet 118 or right outlet 128 (not shown), and onto the work surface at which time it can be shaped by blade 142. As mentioned, in an embodiment of the invention, excess material can be drawn into a storage facility within housing 302, as depicted by the arrows 500 in FIG. 21.

The embodiment of FIG. 23 is similar to that of FIGS. 18 through 22, with the primary exception being that rather than designed for use in association with a foam formed from two separate components, in FIG. 23 housing 302 is designed to accommodate a standard aerosol foam canister 400. Here canister or can 400 is inserted within a receptacle 401 such that its applicator 402 engages an internal actuator 403 that causes a release of the foam when desired. Actuator 403 could be any one of a wide variety of mechanical, electro mechanical, or other such actuators. Other than routine modifications that may be required to foaming head 100 to allow it to accommodate the application of foam from a canister, (such modifications being apparent to one of ordinary skill), the embodiment of FIG. 23 is substantially the same as that of FIGS. 18 through 22.

It will thus be understood that the embodiment of the invention shown in FIGS. 18 through 23 enables for the creation of mouldings in the nature of those discussed with respect to FIGS. 1 through 17, but in a less labour-intensive manner. On-board logic within robot carrier 300 could also be used to control the application rate of the foam, the speed at which forming head 303 is moved along a work surface, and, together with pre-programmed data concerning the rate at which the foam product hardens or sets, control the overall moulding formation process in a manner that helps to maximize efficiency.

In a further aspect of the invention, forming head 100 may be equipped with one or more light sources 600 that emit a wavelength of light that reduces the drying/curing time of foam 150. To increase the rate of formation of moulding 152, foam 150 may be exposed to a pre-determined wavelength of light, thereby accelerating its curing and hardening processes. If desired, and particularly in the embodiment of robotic carrier 300, one or more temperature sensors 601 may be utilized to monitor ambient temperature. When the ambient temperature drops below a pre-determined level, the central processor of the robotic carrier can activate light source 600 to accelerate foam curing and hardening.

In yet a further embodiment, forming head 100 may include a reservoir for receiving a colouring agent that can be added at the mixing stage of foam 150 in order to impart a desired colour to the finished foam product.

It should be apparent to persons skilled in the arts that various modifications and adaptation of this structure described above are possible without departure from the spirit and scope of the invention.

What is claimed is:

1. An apparatus for the in-situ formation of a moulding, the apparatus comprising:
a forming head comprising a body having a raw material receiver, the body further having one or more outlets to permit the movement of raw material from said raw material receiver through an outer surface of said body and into an area adjacent to a work surface when said forming head is positioned in proximity to the work surface; and
a forming blade secured to said body, said blade imparting a desired profile shape to raw material deposited adjacent to the work surface as said forming head is moved along the work surface.

2. The apparatus as claimed in claim 1, wherein said body includes two outlets positioned 90° to one another and on intersecting sides of said body.

3. The apparatus as claimed in claim 1, wherein said body includes one or more guide edges for contacting the work surface and to assist in maintaining said body a pre-determined distance from the work surface as said forming head is moved along the work surface.

4. The apparatus as claimed in claim 3, wherein said one or more guide edges are vertically adjustable on said body.

5. The apparatus as claimed in claim 1, wherein said forming blade includes a forming edge having contours that define the exterior profile imparted to the deposited raw material.

6. The apparatus as claimed in claim 5, wherein said forming blade is releasably securable to said body to permit the exchange of blades for imparting different profiles on the raw material.

7. The apparatus as claimed in claim 1, wherein the raw material is a structural foam formed from mixing two component liquids, said two liquids independently delivered under pressure to the raw material receiver and fed into a mixing chamber within said body prior to being delivered to said one or more outlets.

8. The apparatus as claimed in claim 7, wherein said body includes at least two outlets, said body having a selector valve to select the outlet to which foam will be directed.

9. The apparatus as claimed in claim 1, including a robotic carrier for autonomous or semi-autonomous movement of said forming head.

10. The apparatus as claimed in claim 9, wherein said robotic carrier includes a battery, an electric drive system, a plurality of proximity sensors, and a microprocessor control.

11. The apparatus as claimed in claim 10, wherein said robotic carrier includes a wireless transmitter and a wireless receiver for remote and wireless control of the movement of said carrier.

12. The apparatus as claimed in claim 1, including one or more raw material reservoirs for retaining a supply of raw material within said body.

13. The apparatus as claimed in claim 1, wherein said receiver is dimensioned to accept the receipt of an aerosol canister containing structural foam such that foam released from the canister is directed to one of said one or more outlets.

14. The apparatus as claimed in claim 7, further comprising a light source that emits a pre-determined wavelength of light that assists in accelerating the curing of the foam.

15. An apparatus for the in-situ formation of a moulding, the apparatus comprising:
a forming head comprising a body having a raw material receiver, the body further having one or more outlets to permit the movement of raw material from said raw material receiver through an outer surface of said body and into an area adjacent to a work surface when said forming head is positioned in proximity to the work surface;
a forming blade secured to said body, said blade imparting a desired profile shape to raw material deposited adjacent to the work surface as said forming head is moved along the work surface;
one or more guide edges for contacting the work surface and to assist in maintaining said body a pre-determined distance from the work surface as said forming head is moved along the work surface; and
a robotic carrier for autonomous or semi-autonomous movement of said forming head, the robotic carrier having a microprocessor control.

16. The apparatus as claimed in claim 15, wherein the raw material is a structural foam formed from two or more liquid components that are combined prior to movement through said one or more outlets, the apparatus further comprising a light source that emits a pre-determined wavelength of light that assists in accelerating the curing of the foam.

17. The apparatus as claimed in claim 16, further comprising a temperature sensor for sensing ambient temperature, wherein a sensed temperature below a pre-determined value causes the microprocessor to activate the light source.
